(19) United States
(12) Patent Application Publication
(10) Pub. No.: US 2012/0269175 A1
(43) Pub. Date: Oct. 25, 2012

(54) EFFICIENT IMPLEMENTATION OF JOINT DETECTION BASED TDSCDMA RECEIVERS

(76) Inventors: Aiguo Yan, Andover, MA (US); Yonggang Hao, Waltham, MA (US); Lidwine Martinot, Cottenham (GB); Marko Kocic, Arlington, MA (US)

(21) Appl. No.: 13/092,128

(22) Filed: Apr. 21, 2011

(51) Int. Cl. H04B 7/216

(52) U.S. Cl. 370/335

(57) ABSTRACT

A TD-SCDMA receiver includes a joint detector that receives an input signal from a transceiver. The joint detector analyzes the input signal to determine whether one or more neighboring cells are used in conjunction with a servicing cell. Also, the joint detector assigns a first matrix that includes all coded channels including those associated with the one or neighboring cells so as to formulate a channel matrix. The joint detector uses a selective ratio that has been minimized to define elements of the first matrix so as to efficiently control the bit-width of the joint detector.

### BACKGROUND OF THE INVENTION

The invention is related to the field of Time Division Synchronous CDMA (TD-SCDMA), and in particular to efficient implementation of joint detection based TDSCDMA receivers.

Time Division Synchronous CDMA (TD-SCDMA) was proposed by China Wireless Telecommunication Standards group (CWTS) and approved by the ITU in 1999 and technology is being developed by the Chinese Academy of Telecommunications Technology and Siemens. TD-SCDMA uses the Time Division Duplex (TDD) mode, which transmits uplink traffic (traffic from the mobile terminal to the base station) and downlink traffic (traffic from the base station to the terminal) in the same frame in different time slots. That means that the uplink and downlink spectrum is assigned flexibly, dependent on the type of information being transmitted. When asymmetrical data like e-mail and internet are transmitted from the base station, more time slots are used for downlink than for uplink. A symmetrical split in the uplink and downlink takes place with symmetrical services like telephony.

### SUMMARY OF THE INVENTION

According to one aspect of the invention, there is provided a TD-SCDMA receiver. The TD-SCDMA includes a joint detector that receives an input signal from a transceiver. The joint detector analyzes the input signal to determine whether one or more neighboring cells are used in conjunction with a servicing cell. The joint detector assigns a first matrix that includes necessary active coded channels including those associated with the one or neighboring cells so as to formulate a channel matrix. The joint detector uses a selective ratio that has been minimized to define elements of the first matrix so as to efficiently control the bit-width of the joint detector.

According to another aspect of the invention, there is provided a method of performing joint detection for coded channels associated with a TD-SCDMA receiver. The method includes receiving an input signal from a transceiver and analyzing the input signal to determine whether one or more neighboring cells are used in conjunction with a servicing cell. Also, the method includes assigning a first matrix having necessary active coded channels including those associated with the one or neighboring cells so as to formulate a channel matrix. A selective ratio has been minimized to define elements of the first matrix so as to efficiently control the bit-width associated with the first matrix.

### BRIEF DESCRIPTION OF THE DRAWINGS

FIG. 1 is a schematic diagram illustrating an exemplary embodiment of the invention;

FIG. 2 is a schematic diagram illustrating an abstract model of the TD-SCDMA used in accordance with the invention;

FIG. 3 is a flow chart illustrating the operations performed by the joint detector in assigning elements of a channel matrix V; and

FIG. 4 is a schematic diagram illustrating the arrangement of an exemplary channel matrix T used in accordance with the invention.

### DETAILED DESCRIPTION OF THE INVENTION

The invention presents a novel technique allowing a joint detector to perform joint detection from signals received from either a serving cell or neighboring cells that possibly have equal power. The joint detector uses a novel scheme in dealing with signals being presented from neighboring cells and a servicing cell by re-ordering the matrix V in such a fashion to reduce bit-width requirement for implementation.

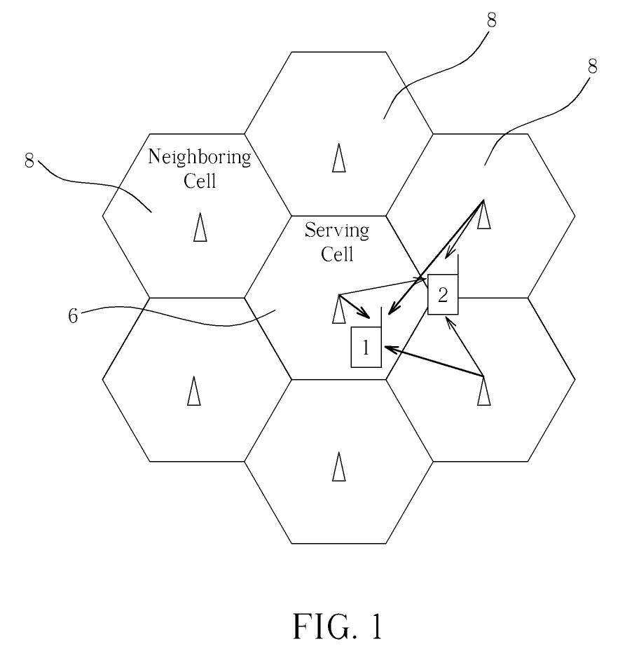

FIG. 1 is a schematic diagram illustrating the invention. TD-SCDMA systems use universal frequency reuse plan, i.e., neighboring cells 8 could immediately reuse the RF carrier frequencies which are used in the serving cell 6. Due to this reason, a handset 1, 2 could receive a signal which is a summation of signals from both serving and neighboring cells. The signal from neighboring cells 8 could also have comparable power levels as the signal from the serving cell 6.

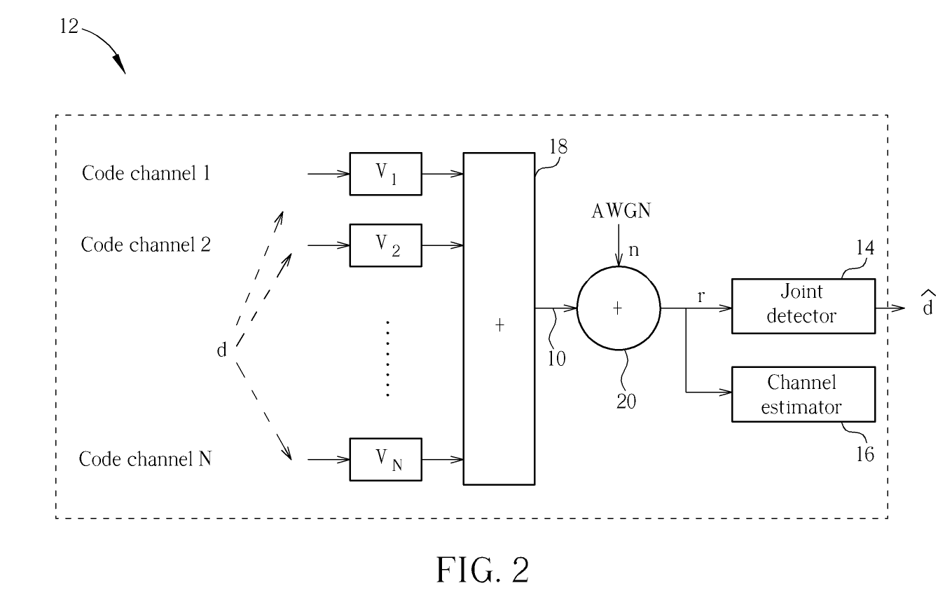

FIG. 2 is a schematic diagram illustrating an abstract model 12 of the TD-SCDMA used in accordance with the invention. A data symbol vector d is provided associated with data symbols from channels 1 . . . N. The values V₁ . . . V_{N} are elements of a matrix V that can define a channel matrix T, which is described further below. The values V₁ . . . V_{N} are combined using a first summation module 18. The first summation module 18 provides an output signal 10 to a second summation module 20. Note the output signal 10 has been processed by a transmitter and transmitted to a TD-SCDMA receiver which is then presented to the second summation module 20. The second summation module 20 adds the output signal 10 and a noise vector n, which defines noise in an Additive White Gaussian Noise (AWGN) associated with a TD-SCDMA receiver. The second summation module 20 provides an output signal r to a joint detector 14 and channel estimator 16. The channel estimator 16 provides an output signal 11 that sends information that aids the joint detector 14 to formulate a channel matrix T. The joint detector 14 receives the output signal r and performs the necessary processing to formulate an estimated data symbol vector d using the novel scheme to re-order matrix V. The scheme of re-ordering matrix V allows the joint detector 14 be implemented with less bit-width.

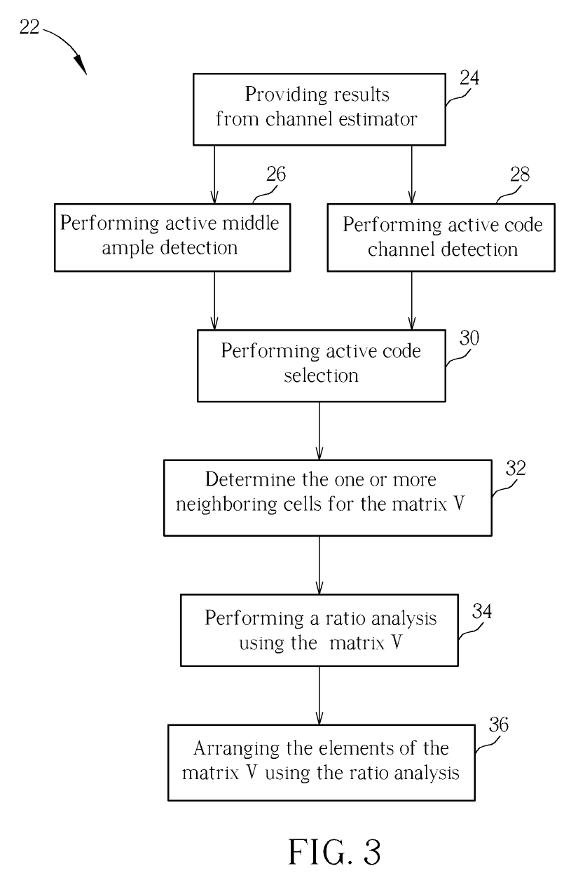

FIG. 3 is a flow chart 22 illustrating the operations performed by the joint detector 14 using the novel scheme of re-ordering matrix V. As shown in step 24, the results of the channel estimator are provided so that active midamble detection (AMAD) and active code channel detection (ACCD). The AMAD performs and analyzes the results of the channel estimator to generate the matrix V associated with a received signal from a transceiver, as shown in step 26. The midamble section of the received signal provides information to produce the matrix V. The ACCD analyzes the results of the channel estimator to determine the respective scaling factors and power levels of the elements V₁ . . . V_{N} of the matrix V, as shown in step 28. The joint detector performs Active Code Selection (ACS) by receiving the results from the AMAD and ACCD to produce an appropriate matrix V for use in later processing in determining an appropriate channel matrix T, as shown in step 30. Also, one determines the one or more neighboring cells for the matrix V, as shown in step 32. Moreover, the receiver performs a ratio analysis on the matrix V to find the optimum arrangement of the elements of the matrix V so as to produce a small bit-width, as shown in step 34. This ratio analysis may be used for arranging the elements of the matrix V so it can define a JD having a small bit-width, as shown in step 36. This ratio analysis has been minimized to determine the optimum arrangements of the matrix elements necessary for forming the matrix V.

The matrix V may then be used to produce the channel matrix T with less bit-width requirement allowing for better estimation of the data symbols received by a TD-SCDMA receiver by neighboring cells and a servicing cell. The scheme utilizes special properties and relationships to reduce the requirement on bit-width, thus improve the efficiency of the JD.

The output signal r can have the following matrix relation:

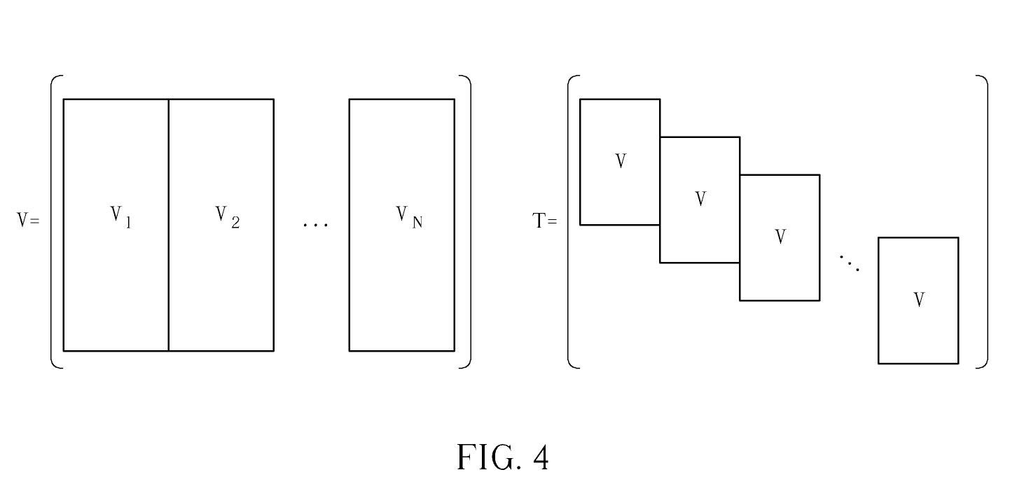

r=Td+n (1)

where the matrix T defines a channel matrix and the vector d defines a vector associated with the input data symbols. The matrices T and V have the following structure, after active code channel detection (ACD) and active midamble detection (AMD), as shown in FIG. 4.

The invention can use a Minimum Mean Squared Error (MMSE) joint detection solution defined as:

(T^{H}T+σ²I)\hat{d}_{MMSE}=T^{H}r (2)

where \hat{d} defines the estimated data symbol vector outputted by the joint detector.

Many times, one may also want to use the Zero-Forcing JD (ZF-JD) to provide a better approximation for \hat{d}, which is defined as:

(T^{H}T)\hat{d}_{ZF}=T^{H}r (3)

where \hat{d}_{ZF} defines the estimated data symbol vector produced using ZF-JD.

One consideration for JD implementation is the bit-width. Especially multi cell Joint Detection is more sensitive to bit-width. Smaller Bit-width not only save size/power consumption but also enables fast clock rate.

The invention is targeted for implementing an efficient JD algorithm with less bit-width requirement. In particular, the invention utilizes a ratio, discussed further below, to assess arranging the elements of the matrix V using properties in the Cholesky decomposition, which is defined as

A=LDL^{H} (4)

where L is a lower triangular matrix with one on the diagonal and D is a real positive diagonal matrix, and

$$det ( A ) = det ( D ) = {\sum }_{i = 1}^{N} {D}_{i} .$$

The ratio

$$\frac{max ( {D}_{i} )}{min ( {D}_{i} )}$$

is a ratio used for determining an efficient JD algorithm. Note Dᵢ is not necessarily an eigen-value of the matrix A.

Therefore, by minimizing the ratio of

$$\frac{max ( {D}_{i} )}{min ( {D}_{i} )} ,$$

it allows for smaller bit-width requirement for the JD implementation. It has been shown by arranging the elements of the matrix V in ascending order (||Vᵢ||₂≦||Vₖ||₂ if k>i.) by power level of each column generated, a smaller ratio for

$$\frac{max ( {D}_{i} )}{min ( {D}_{i} )}$$

can be obtained. One possibility without prohibitive increase to computation complexity is to re-order the elements of the matrix V in descending or ascending order by power level of each column

For another version of Cholesky decomposition A=P P^{H}, one can easily see that

$${a}_{i , i} = {\sum }_{k = 1}^{i} \vert {p}_{i , k} {\vert}^{2} .$$

So that 1≧max (a_{i,i})>0 will automatically guarantee |p_{i,k}|≦1.

Thus, the invention takes into consideration using the ratio

$$\frac{max ( {D}_{i} )}{min ( {D}_{i} )}$$

and minimizing it so as to allow for a matrix V to have a small bit-width requirement. The re-order of the elements of the matrix V based on this ratio allows for a highly efficient JD without significant computational resources.

In one aspect, the novel joint detection in general increases BER/BLER/throughput performance with less bit-width requirement.

Although the present invention has been shown and described with respect to several preferred embodiments thereof, various changes, omissions and additions to the form and detail thereof, may be made therein, without departing from the spirit and scope of the invention.

What is claimed is:

1. A TD-SCDMA receiver comprising a joint detector that receives an input signal from a transceiver, the joint detector analyzes the input signal to determine whether one or more neighboring cells are used in conjunction with a servicing cell, the joint detector assigns a first matrix that includes all coded channels including those associated with the one or neighboring cells so as to formulate a channel matrix, the joint detector uses a selective ratio that has been minimized to define elements of the first matrix so as to efficiently control the bit-width of the joint detector.

2. The TD-SCDMA receiver of claim 1, wherein the joint detector analyzes the midamble data of the input signal to form the first matrix.

3. The TD-SCDMA receiver of claim 1, wherein the joint detector uses active code channel detection to assign power levels to the elements of the first matrix.

4. The TD-SCDMA receiver of claim 1, wherein the joint detector uses active midamble detection to determine the one or more neighboring cells.

5. The TD-SCDMA receiver of claim 1, wherein the joint detector comprises 1X or 2X joint detection.

6. The TD-SCDMA receiver of claim 1, wherein the joint detector uses Minimum Mean Squared Error (MMSE) or Zero-Forcing joint detection to determine an estimated data symbol.

7. The TD-SCDMA receiver of claim 1, wherein the joint detector formulates the first matrix to have full rank as well as the channel matrix.

8. The TD-SCDMA receiver of claim 1, wherein the first matrix is insensitive to small approximations errors.

9. The TD-SCDMA receiver of claim 1, wherein the selective ratio uses properties in Cholesky decomposition.

10. The TD-SCDMA receiver of claim 1, wherein the first matrix comprises an arrangement that reduces the bit-width requirement for the joint detector.

11. A method of performing joint detection for coded channels associated with a TD-SCDMA receiver comprising:
receiving an input signal from a transceiver;
analyzing the input signal to determine whether one or more neighboring cells are used in conjunction with a servicing cell; and
assigning a first matrix that includes all coded channels including those associated with the one or neighboring cells so as to formulate a channel matrix ,a selective ratio has been minimized to define elements of the first matrix so as to efficiently control the bit-width associated with the first matrix.

12. The method of claim 11, wherein the analyzing the input signal step comprises analyzing the midamble data of the input signal to form the first matrix.

13. The method of claim 11, wherein the assigning a first matrix step comprises assigning power levels to the elements of the first matrix.

14. The method of claim 11, wherein the analyzing the input signal step comprises using active midamble detection to determine the one or more neighboring cells.

15. The method of claim 11, wherein the TD-SCDMA receives comprises 1X or 2X joint detection.

16. The method of claim 11, wherein the assigning a first matrix step comprises using MMSE or Zero-Forcing joint detection to determine an estimated data symbol.

17. The method of claim 11, wherein the assigning a first matrix step comprises formulating the first matrix to have full rank as well as the channel matrix.

18. The method of claim 11, wherein the first matrix is insensitive to small approximations errors.

19. The method of claim 11, wherein one selective ratios uses properties in Cholesky decomposition.

20. The method of claim 11, wherein the first matrix comprises an arrangement that reduces the bit-width requirement for the joint detector.
